(19) United States
(12) Patent Application Publication
(10) Pub. No.: US 2014/0332031 A1
(43) Pub. Date: Nov. 13, 2014

(54) Pipe Cleaning System and Method

(71) Applicant: Curry Paul Leggett, Terry, MS (US)

(72) Inventor: Curry Paul Leggett, Terry, MS (US)

(21) Appl. No.: 13/891,866

(22) Filed: May 10, 2013

(51) Int. Cl. B08B 9/032; B08B 9/055

(52) U.S. Cl. CPC B08B 9/0322; B08B 9/055
USPC 134/8; 15/3.51

(57) ABSTRACT

An HVAC pipe cleaning system includes a pipe cleaning adapter attached to the upstream end of a pipe and a catch device attached to the downstream end of the pipe k cylindrical wiper is closely fitted into the interior of the pipe cleaning adapter and is propelled from the pipe adapter into the pipe by means of gas pressure behind the cylindrical wiper. A flushing solvent fitting is used to inject flushing solvent into the pipe cleaning adapter ahead of the wiper.

### CROSS REFERENCE TO RELATED PATENT APPLICATIONS

This invention claims priority from U.S. Provisional Patent Application No. 61/688,262, filed May 11, 2012, which is hereby incorporated by reference.

### FIELD OF THE INVENTION

This invention relates to a system and method for cleaning pipes, particularly refrigerant lines in heating, ventilation, and air-conditioning (HVAC) systems.

### BACKGROUND OF THE INVENTION

In an HVAC system a refrigerant line may require cleaning when, for example, a R-410A refrigerant retrofit is undertaken, a refrigerant conversion is made, or a compressor burnout occurs. Currently, such cleaning is accomplished by using a flushing solvent, such as Pro-Flush® HVAC Flushing Solvent, manufactured and sold by DiversiTech Corporation of Duluth, Ga. The flushing solvent is injected from a pressurized tank at 50 psi into the refrigerant lines in 3-second increments for a total of about 2-3 ounces per ton of air-conditioning capacity. Subsequently, the refrigerant line is purged with nitrogen gas at about 150 psi for 1-2 minutes to remove trace amounts of oil residue and solvent.

vile cleaning a refrigerant line with the flushing solvent is generally effective, in some circumstances the purging step may not always remove all traces of oil residue and the flushing solvent.

### SUMMARY OF THE INVENTION

The present invention provides a system and method for more effectively removing traces of oil residue and flushing solvent. Particularly, the pipe cleaning system includes a pipe cleaning adapter attached to the upstream end of the pipe to be cleaned and a catch device attached to the downstream end of the pipe to be cleaned.

The pipe cleaning adapter comprises a hollow, cylindrical housing that is open at both ends. The downstream housing opening of the pipe cleaning adapter is sealingly connected to the upstream pipe end of the pipe to he cleaned. The upstream housing opening of the pipe cleaning adapter accommodates an end plug, typically by threading the end plug into the upstream housing opening of the pipe cleaning adapter. The end plug includes a gas pressure fitting for attachment to a source of gas pressure. A gas channel extends through the end plug and connects the gas pressure fitting to the interior of the hollow, cylindrical housing when the end plug is in place in the upstream opening of the hollow, cylindrical housing. The pipe cleaning adapter also has a flushing solvent injector fitting with a check valve that communicates with the interior of the hollow housing of the pipe cleaning adapter near the midpoint of the length of the pipe cleaning adapter. A cylindrical wiper is closely fitted into the interior of the hollow, cylindrical housing adjacent the end plug.

The catch device comprises a container with a vent attached to the downstream pipe end. The catch device may take the form of a catch net with a mesh smaller than the size of the cylindrical wiper. One end of the catch net is attached to the pipe, and other end of the catch net is spaced from the downstream pipe end is closed.

In one embodiment of the pipe cleaning method of the present invention, the cleaning method involves two cleaning runs. In each cleaning run the cylindrical wiper is propelled through the pipe by means of gas pressure behind the cylindrical wiper. The first embodiment of the pipe cleaning method therefore includes the steps of attaching and securing the catch device to the downstream pipe end and attaching and securing the pipe cleaning adapter to the upstream pipe end. With the pipe cleaning adapter secured to the upstream pipe end, the first run includes inserting a first properly sized cylindrical wiper into the upstream housing opening of the pipe cleaning adapter. With the cylindrical wiper in place in the interior of the hollow, cylindrical housing, the end plug is secured in the upstream housing opening. The cylindrical wiper is then propelled through the pipe by applying sufficient gas pressure to the gas pressure fitting in the end plug to force the wiper through the pipe and into the catch device at the downstream pipe end. After the first cylindrical wiper has been captured by the catch device, the end plug is removed, and the second rim includes inserting a second properly sized cylindrical wiper into the upstream housing opening of the pipe cleaning adapter. After the end plug has been reinstalled in the upstream housing opening and before gas pressure is applied, an effective amount of flushing solvent is injected into the interior of the hollow, cylindrical housing through the flushing solvent injector fitting. After the flushing solvent has been injected into the interior of the hollow, cylindrical housing, the flushing solvent injector fitting is sealed, and sufficient gas pressure is applied through the gas pressure fitting to propel the second cylindrical wiper through the pipe, pushing the flushing solvent ahead of cylindrical wiper.

Other embodiments of the method of the present may include a single run using a single wiper with or without flushing solvent or may include a plurality of runs with or without flushing solvent.

Further objects, features and advantages will become apparent upon consideration of the following detailed description of the invention when taken in conjunction with the drawings and the appended claims.

### BRIEF DESCRIPTION OF THE DRAWINGS

FIG. 1 is a side elevation view in cross-section of a pipe cleaning adapter of a pipe cleaning system attached to an upstream pipe end in accordance with the present invention.

FIG. 2 is a side elevation view of a catch device in the form of a catch net of a pipe cleaning system attached to downstream pipe end in accordance with the present invention.

### DETAILED DESCRIPTION OF THE PREFERRED EMBODIMENTS

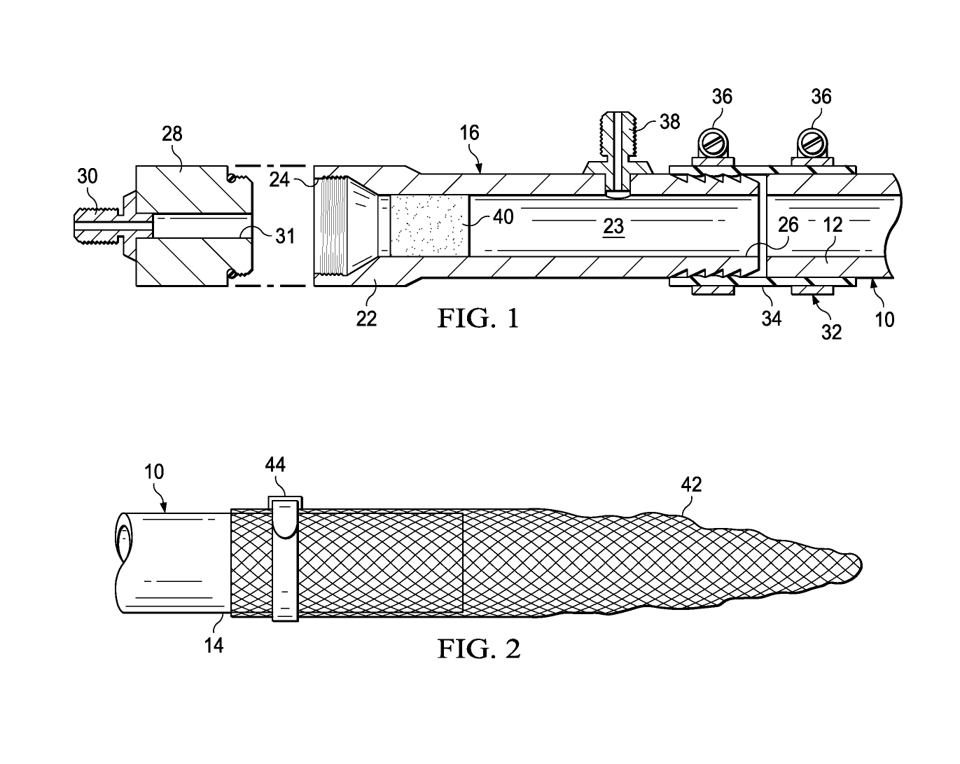

Turning to FIGS. 1 and 2, a pipe cleaning system of the present invention includes a pipe cleaning adapter 16 (FIG. 1) attached to the upstream end 12 of a pipe 10 to be cleaned and a catch net 42 (FIG. 2) attached to the downstream end 14 of the pipe 10 to be cleaned.

With continuing reference to FIG. 1, the pipe cleaning adapter 16 comprises a cylindrical housing 22 with hollow interior 23 that is open at both ends 24 and 26. The downstream housing opening 26 of the pipe cleaning adapter 16 is sealingly connected to the upstream pipe end 12 of the pipe 10 to be cleaned by means of a pipe clamp 32 comprising a hose 34 and base clamps 36. Other fittings may be used to attach the pipe cleaning adapter 16 to the upstream pipe end 12 to ensure a secure and leakproof attachment. The pipe cleaning adapter 16 may he constructed of metal or plastic, the requirements being that the material used is sufficient to withstand the pressures used in connection with the method of the present invention and to withstand the flushing solvents used in connection with the method of the present invention.

The upstream housing opening 24 of the pipe cleaning adapter 16 accommodates an end plug 28, typically by threading the end plug 28 into the upstream housing opening 24 of the pipe cleaning adapter 16. The end plug 28 includes a gas pressure fitting 30 with a gas channel 31 extending through the end plug 28 and connecting the gas pressure fitting 30 to the interior 23 of the hollow, cylindrical housing 22 when the end plug 28 is in place in he upstream opening 24 of the hollow, cylindrical housing 22.

The pipe cleaning adapter 16 also has a flushing solvent injector fitting 38 that communicates with the interior 23 of the hollow housing 22 of the pipe cleaning adapter 16 near the midpoint of the length of the pipe cleaning adapter 16. The solvent injector fitting 38 is configured to attach to a standard injector system (not shown) for delivery of flushing solvents. The solvent injector fitting 38 also includes a check valve (not shown) that prevents backflow of gas or flushing solvent from the interior 23 of the hollow, cylindrical housing 22.

A cylindrical wiper 40 is closely fitted into the interior 23 of the hollow, cylindrical housing 22 adjacent the end plug 28. The cylindrical wiper 40 may be constructed of a number of materials including open or closed cell foam rubber, either natural or synthetic rubber or foamed plastic. The material for the cylindrical wiper 40 should be selected to withstand the pressures used in connection with the method of the present invention and to withstand the flushing solvents used in connection with the method of the present invention. In addition, the material of the cylindrical wiper 40 should be able to absorb oil and flushing solvent as the cylindrical wiper 40 is propelled through the pipe 10. Finally, the cylindrical wiper 40 should have a coefficient of friction that is compatible with the coefficient of friction of the interior 23 of the housing 22 of the pipe cleaning adapter 16 so that excessive gas pressure is not required to propel the cylindrical wiper 40 through the pipe 10.

The catch net 42 is a net with a mesh smaller than the size of the cylindrical wiper 40. Air open end of the catch net is attached to the downstream pipe end 14 of the pipe 10 by means of a tie wrap 44. The other end of the catch net 42 is spaced from the downstream pipe end 14 and is closed for example by means of a clip 46 in order to recover the pipe wiper 40 without removing the catch net 42 from the pipe end 14. In addition to the catch net 42, a receptacle with a vent (not shown) may be employed to catch the cylindrical wiper 40 and to recover oil, refrigerant, and flushing solution at the downstream pipe end 14.

In one embodiment of the pipe cleaning method of the present invention, the cleaning method involves two cleaning runs. In each cleaning run the cylindrical wiper 40 is propelled through the pipe 10 by means of gas pressure behind the cylindrical wiper 40. The first embodiment of the pipe cleaning method therefore includes the steps of attaching and securing the catch net 42 to the downstream pipe end 14 and attaching and securing the pipe cleaning adapter 16 to the upstream pipe end 12. With the pipe cleaning adapter 16 secured to the upstream pipe end 12, the first run includes inserting a first properly sized cylindrical wiper 40 into the upstream housing opening 24 of the pipe cleaning adapter 16. With the cylindrical wiper 40 in place in the interior 23 of the hollow, cylindrical housing 22, the end plug 28 is secured in the upstream housing opening 24 by means of a threaded connection. A source of compressed gas (not shown), such as nitrogen, is connected to the gas pressure fitting 30. The gas pressure is slowly increased until the cylindrical wiper 40 is propelled through the pipe 10 and into the catch net 42 at the downstream pipe end 14. After the first cylindrical wiper 40 has been captured by the catch net 42, the end plug 28 is removed, and the second run includes inserting a second properly sized cylindrical wiper 40 into the upstream housing opening 24 of the pipe cleaning adapter 16. After the end plug 28 has been reinstalled in the upstream housing opening 24 and before gas pressure is applied, an effective amount of flushing solvent from a flushing solvent delivery system (not shown) is injected into the interior 23 of the hollow, cylindrical housing 22 through the flushing solvent injector fitting 38. An effective amount of flushing solvent is approximately 2-3 oz/ton of air-conditioning capacity. After the flushing solvent has been injected into the interior 23 of the hollow, cylindrical housing 22, the gas pressure is slowly increased through the gas pressure fitting 30 to propel the second cylindrical wiper 40 through the pipe 10, pushing the flushing solvent ahead of cylindrical wiper 40. The check valve (not shown) in the flushing solvent injector fitting 38 prevents backflow of gas or flushing solvent from the interior 23 of the hollow, cylindrical housing 22.

Another embodiment the method of the present invention includes a single run using a single wiper 40 with flushing solvent or without flushing solution. A further embodiment of the present invention includes a plurality of runs using a plurality of wipers 40 with or without flushing solvent.

While this invention has been described with reference to preferred embodiments thereof, it is to be understood that variations and modifications can be affected within the spirit and scope of the invention as described herein and as described in the appended claims.

I claim:

1. A pipe clean system for cleaning a pipe having an upstream pipe end and a downstream pipe end comprising:
a. a pipe cleaning adapter connected to the upstream pipe end and comprising:
i. a hollow, cylindrical housing having an interior and a length and having:
(a) an upstream housing opening; and
(b) a downstream housing opening;
ii. an end plug fitted to the upstream housing opening, the end plug having a gas pressure fitting and a gas channel between the end plug gas pressure fitting and the interior of the hollow cylindrical housing; and
iii. a wiper located in the cylindrical housing adjacent the upstream housing opening to be propelled through the interior of the cylindrical housing and into the pipe;
b. a catch device connected to the downstream pipe end.

2. The pipe cleaning system of claim 1, wherein the cylindrical housing has a flushing solvent injector fitting positioned downstream of the wiper end in communicating with the interior of the hollow cylindrical housing.

3. A method for cleaning a pipe having an upstream pipe end and a downstream pipe end comprising the steps of:
a. connecting a catch device to the downstream pipe end.
b. connecting a pipe cleaning adapter to the upstream pipe end, wherein the pipe cleaning adapter comprises:
i. a hollow, cylindrical housing having an interior and a length and having:
(a) an upstream housing opening; and
(b) a downstream housing opening;
c. fitting an end plug into the upstream housing opening, the end plug having a gas pressure fitting and a gas channel between the end plug gas pressure fitting and the interior of the hollow cylindrical housing;
d. placing a wiper in the cylindrical housing adjacent the upstream housing opening;
e. propelling the wiper through the interior of the cylindrical housing and through pipe by means of as pressure behind the wiper; and
f. catching the wiper in the catch device.

4. The method of claim 3, wherein flushing solvent is injected into the cylindrical housing downstream of the wiper prior to the wiper being propelled through the interior of the cylindrical housing and through the pipe by means of gas pressure behind the wiper.
